(19) United States
(12) Patent Application Publication
(10) Pub. No.: US 2024/0220003 A1
(43) Pub. Date: Jul. 4, 2024

(54) OPERATION DEVICE, CONTROL DEVICE THEREOF, CONTROL METHOD, AND PROGRAM

(71) Applicant: Sony Interactive Entertainment Inc., Tokyo (JP)

(72) Inventor: Hitoshi Nakamura, Tokyo (JP)

(73) Assignee: Sony Interactive Entertainment Inc., Tokyo (JP)

(21) Appl. No.: 18/580,270

(22) PCT Filed: Sep. 14, 2021
(86) PCT No.: PCT/JP2021/033726

§ 371 Date: Jan. 18, 2024

(51) Int. Cl. G06F 3/01; A63F 13/218

(52) U.S. Cl. CPC G06F 3/011; A63F 13/218

(57) ABSTRACT

Provided is an operation device including an operation member configured to receive an operation performed by a user and a temperature sensation presentation unit that is disposed on a surface of the operation member and that is configured to present warm sensation and/or cold sensation to a part of a body of the user that is operating the operation member.

### TECHNICAL FIELD

The present invention relates to an operation device including an operation member for receiving an operation performed by a user, a control device thereof, a control method, and a program.

### BACKGROUND ART

For example, in a video game, tactile presentation is sometimes performed for the purpose of allowing users to have a more realistic experience. Known as a method of performing tactile presentation is to present force sensation to a user by vibrating the device that comes into contact with the body of a user or applying force to the body of the user.

### SUMMARY

### Technical Problem

In the technical field of virtual reality, for example, users have become able to have various virtual experiences. In association with this, more diverse expressions are required for tactile presentation.

The present invention has been made with the abovementioned circumstances taken into consideration, and has, as an object thereof, provision of an operation device, a control device thereof, a control method, and a program that are capable of performing tactile presentation in a new form.

### Solution to Problem

An operation device according to one aspect of the present invention includes an operation member configured to receive an operation performed by a user and a temperature sensation presentation unit that is disposed on a surface of the operation member and that is configured to present warm sensation and/or cold sensation to a part of a body of the user that is operating the operation member.

A control device of an operation device according to one aspect of the present invention is a control device of an operation device including an operation member configured to receive an operation performed by a user and a temperature sensation presentation unit configured to present warm sensation and/or cold sensation to a part of a body of the user that is operating the operation member, the control device including an acquisition unit configured to acquire details of the operation performed by the user on the operation member and a control unit configured to cause the temperature sensation presentation unit to present warm sensation and/or cold sensation with contents corresponding to the acquired details of operation.

A control method for an operation device according to one aspect of the present invention is a control method for an operation device including an operation member configured to receive an operation performed by a user and a temperature sensation presentation unit configured to present warm sensation and/or cold sensation to a part of a body of the user that is operating the operation member, the control method including a step of acquiring details of the operation performed by the user on the operation member and a step of causing the temperature sensation presentation unit to present warm sensation and/or cold sensation with contents corresponding to the acquired details of operation.

A program according to one aspect of the present invention is a program for controlling an operation device including an operation member configured to receive an operation performed by a user and a temperature sensation presentation unit configured to present warm sensation and/or cold sensation to a part of a body of the user that is operating the operation member, the program causing a computer to execute a step of acquiring details of the operation performed by the user on the operation member and a step of causing the temperature sensation presentation unit to present warm sensation and/or cold sensation with contents corresponding to the acquired details of operation. The program may be stored in a computer-readable non-transitory information storage medium and provided.

### BRIEF DESCRIPTION OF DRAWINGS

FIG. 1 is a general overview diagram illustrating an information processing system according to an embodiment of the present invention.

FIG. 2 is a diagram illustrating an example of an external appearance of an operation device according to the embodiment of the present invention.

FIG. 3 is a diagram illustrating an internal configuration of the operation device according to the embodiment of the present invention.

FIG. 4 depicts diagrams illustrating an example of a push-in amount measurement mechanism.

FIG. 5 is a diagram illustrating an example of a rule table.

FIG. 6 is a flowchart illustrating an example of a flow of processing performed by a controller of the operation device.

FIG. 7 depicts diagrams illustrating an example of arrangement of temperature sensation presentation units.

FIG. 8 is a diagram illustrating an example of arranging the temperature sensation presentation units on a touch pad.

### DESCRIPTION OF EMBODIMENT

An embodiment of the present invention will hereinafter be described in detail in reference to the drawings.

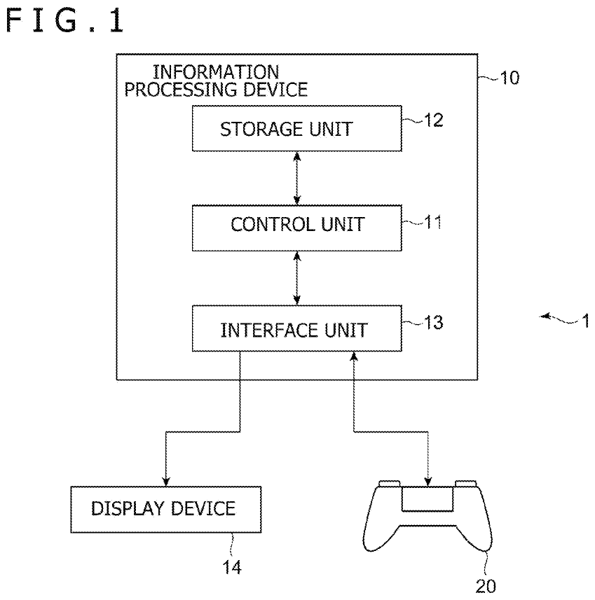

FIG. 1 is a general overview diagram of an information processing system 1 including an operation device 20 according to an embodiment of the present invention. As illustrated in FIG. 1, the information processing system 1 includes an information processing device 10, a display device 4, and the operation device 20.

The information processing device 10 is a home video game console, a personal computer, or a large-scale computer group disposed on a network cloud, and includes a control unit 11, a storage unit 12, and an interface unit 13. The control unit 11 includes at least one processor, and executes various kinds of information processing in accordance with programs stored in the storage unit 12. The storage unit 12 includes at least one memory device, and stores various kinds of programs and data used for the information processing executed by the control unit 11. The interface unit 13 is a communication interface, and controls data communication performed with the display device 14 and the operation device 20. The display device 14 displays video corresponding to the video signal transmitted from the information processing device 10 and presents the video to the user. The display device 14 may be a display device of a head-attaching type that is capable of displaying stereoscopic video by being attached to the head of the user. The information processing device 10 according to the present embodiment executes an application program as exemplified by a game and causes the display device 14 to display the video indicating the result of such execution.

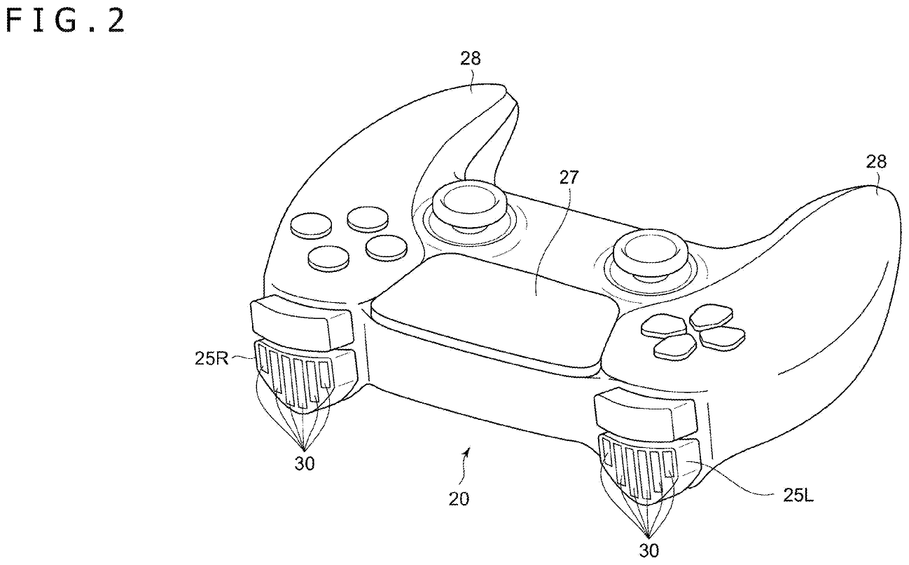

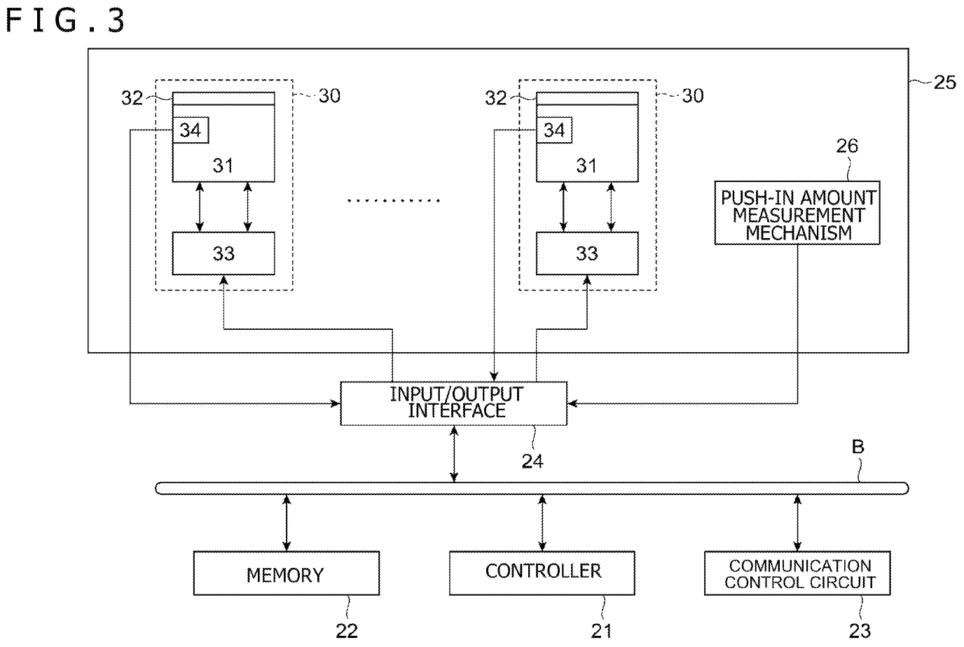

The operation device 20 is a device for receiving an instruction given by a user for operation of the information processing device 10, and is connected to the information processing device 10 in a wired or wireless manner to be able to perform data communication therewith. FIG. 2 is a diagram illustrating an example of an external appearance of the operation device 20. Further, FIG. 3 is a diagram illustrating part of an internal configuration of the operation device 20. As illustrated in these figures, the operation device 20 includes a controller 21, a memory 22, a communication control circuit 23, and an input/output interface 24. These circuit elements are connected to one another via a bus B.

The operation device 20 includes trigger buttons 25, a touch pad 27, and various operation buttons, as operation members that are to be operated by the user. Moreover, the operation device 20 includes holding portions 28 that are portions to be gripped by the palms of the left and right hands of the user.

The controller 21 is a microprocessor, for example, and executes various kinds of information processing in accordance with built-in programs. Specifically, the controller 21 periodically scans the states of various operation members disposed on a surface of the operation device 20, and identifies the operation performed by the user on the operation members. Further, the controller 21 controls temperature sensation presentation units 30 to perform various kinds of tactile presentation for the user. Details of the processing performed by the controller 21 will be described later.

The memory 22 stores various kinds of information used for the processing performed by the controller 21. Specifically, the memory 22 stores information indicating the details of operation performed on the various operation members that are obtained by the controller 21 as a result of the periodic scanning. Further, the memory 22 stores details of the instruction related to the operation of the operation device 20 that is received from the information processing device 10.

The communication control circuit 23 controls data communication performed with the information processing device 10. Specifically, the communication control circuit 23 transmits, to the information processing device 10, such data as information indicating the details of operation stored in the memory 22, according to the instruction given by the controller 21. Further, the communication control circuit 23 stores such data as details of the instruction received from the information processing device 10 in the memory 22.

The input/output interface 24 relays data between the temperature sensation presentation units 30 or a push-in amount measurement mechanism 26 to be described later and the bus B. Specifically, the input/output interface 24 transmits, to the temperature sensation presentation units 30, control commands from the controller 21, and receives data transmitted from the temperature sensation presentation units 30 or the push-in amount measurement mechanism 26, to record such data in the memory 22.

Disposed on the surface of the operation device 20 are operation members as exemplified by operation buttons. In particular, in the present embodiment, on a front surface of the operation device 20, there are provided two trigger buttons 25 including a trigger button 25R that is to be operated by the user with his/her right index finger and a trigger button 25L that is to be operated by the user with his/her left index finger. Yet, in FIG. 3, a configuration corresponding to one of the two trigger buttons 25 is illustrated. The trigger buttons 25 can be pushed in; the user can press his/her index finger against a surface of the corresponding trigger button 25, apply force, and push in the trigger button 25.

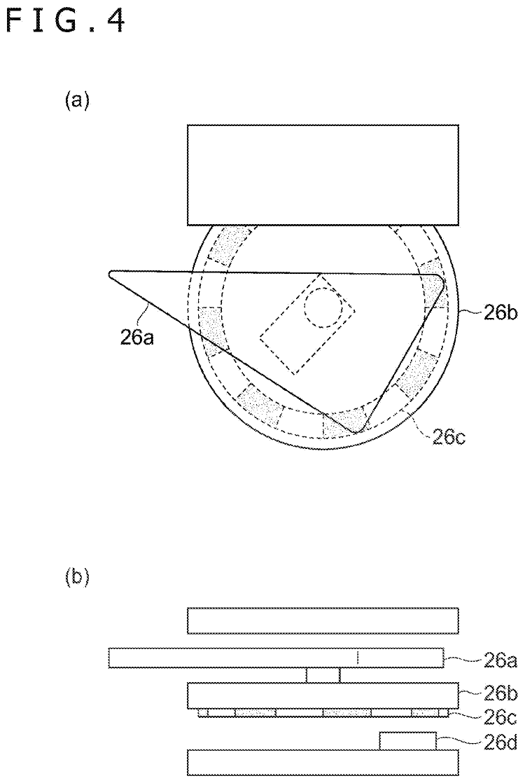

Inside each of the trigger buttons 25, the push-in amount measurement mechanism 26 used for measuring the extent to which the user has pushed in the trigger button 25 is provided. By referring to the results of measurement performed by the push-in amount measurement mechanism 26, the controller 21 can identify not only whether or not the user has pressed down the trigger buttons 25 but also the extent to which the user has pushed in the trigger buttons 25. FIG. 4 depicts diagrams for illustrating an example of an operating principle of the push-in amount measurement mechanism 26, and schematically illustrates positional relations between major constituent elements of the push-in amount measurement mechanism 26. FIG. 4(a) is a plan view, while FIG. 4(b) is a side elevational view. In this example, a crank 26a is coupled to an outer shell of the trigger button 25. When the user presses down the trigger button 25, the crank 26a operates in an interlocking relation with the outer shell of the trigger button 25, and the movement is converted into rotational movement of a gear 26b. On one side of the gear 26b, magnets 26c are disposed in an annular shape along an outer circumference thereof. On a lower side of the gear 26b, a magnetoresistive (MR) sensor 26d is disposed, and detects magnetic field variations that occur in association with the rotation of the magnets 26c in a non-contact manner. This allows the push-in amount measurement mechanism 26 to measure the rotation amount of the gear 26b with use of the results of detection by the MR sensor 26d. Note that, the push-in amount measurement mechanism 26 is not limited to having such a configuration, and may be one that measures the push-in amount by various methods.

Near the surface of each of the trigger buttons 25, a plurality of temperature sensation presentation units 30 are provided. Each of the temperature sensation presentation units 30 includes a thermoelectric element section 31, a heat dissipation member 32, a source circuit 33, and a temperature sensor 34. Each temperature sensation presentation unit 30 is used to present a sense of hotness or coldness to the body of the user by heat generation and heat absorption by the thermoelectric element section 31.

In the example illustrated in FIG. 2, the heat dissipation member 32 of each of the temperature sensation presentation units 30 is exposed on the surface of each of the trigger buttons 25, and the exposed portion has a long, thin reed shape extending in the vertical direction. Moreover, each of the plurality of trigger buttons 25 has six temperature sensation presentation units 30 disposed side by side in the left-right direction (that is, the direction intersecting the extension direction of the heat dissipation members 32). Yet, the number, shape, and arrangement form of the temperature sensation presentation units 30 illustrated in FIG. 2 are mere examples, and may have variation. Other examples of the arrangement form of the temperature sensation presentation units 30 will be described later.

The heat dissipation member 32 is formed with a material having high heat conductivity and has a thin plate shape. The heat dissipation member 32 is disposed to face a portion of the surface of the corresponding trigger button 25 that comes into contact with the body of the user that operates the trigger button 25. On a side of the heat dissipation 32 that is opposite the surface side of the trigger button 25, the thermoelectric element section 31 is disposed in such a manner as to come into contact with that side of the heat dissipation member 32. Note that the heat dissipation member 32 is exposed on the surface of the trigger button 25 here, but the heat dissipation member 32 may instead be covered with a cover having heat conductivity.

The thermoelectric element section 31 includes a thermoelectric element that generates heat and/or absorbs heat when a current is being flowed therein. This thermoelectric element may, for example, be a small Peltier element. Note that one thermoelectric element section 31 may include a plurality of thermoelectric elements. The thermoelectric element section 31 is connected to the source circuit 33, and the source circuit 33 causes a current to flow in the thermoelectric element section 31 in accordance with the control commands received from the controller 21. In a case where the thermoelectric element section 31 includes a Peltier element, the source circuit 33 causes a current in a predetermined direction to flow in the thermoelectric element section 31, and the side of the thermoelectric element section 31 that comes into contact with the heat dissipation member 32 thereby generates heat. As a result, the body of the user is heated via the heat dissipation member 32, and a sense of hotness (warm sensation) is presented to the user. When a current that flows in a direction opposite to that at the time of heat generation is caused to flow into the thermoelectric element section 31, the thermoelectric element section 31 absorbs heat from the side where the thermoelectric element section 31 comes into contact with the heat dissipation member 32. As a result, the body of the user is cooled via the heat dissipation member 32, and a sense of coldness (cold sensation) is presented to the user. As described above, controlling the direction of the current flowing in the thermoelectric element section 31 makes it possible to use one temperature sensation presentation unit 30 for presenting both warm sensation and cold sensation.

The source circuit 33 causes a current to flow in the corresponding thermoelectric element section 31, according to instructions received from the controller 21 via the input/output interface 24. In the present embodiment, the source circuit 33 is configured to be capable of causing a current to flow in the thermoelectric element section 31 in both directions, in order to correspond to both heat generation and heat absorption by the thermoelectric element section 31.

Each thermoelectric element section 31 has a temperature sensor 34 disposed adjacent thereto, and the temperature sensor 34 measures, on a real time basis, the temperature as of the time when the thermoelectric element section 31 is operated. The controller 21 monitors the results of measurement performed by the temperature sensor 34, and performs feedback control. As a result, the controller 21 is able to execute heating or cooling control such that the temperature to be presented by each thermoelectric element section 31 reaches a given target temperature.

As described above, in the present embodiment, a plurality of temperature sensation presentation units 30 are disposed on the surface of one trigger button 25. The thermoelectric element sections 31 constituting the respective temperature sensation presentation units 30 are configured to be capable of performing heating or cooling control independently of each other, and are capable of independently presenting a desired temperature. When all of the thermoelectric element sections 31 are caused to generate heat, warm sensation can be presented to the body of the user (here, the ball of the index finger operating the trigger button 25). Conversely, causing the thermoelectric element sections 31 to absorb heat makes it possible to present cold sensation to the body of the user.

In the following description, a specific example of contents of control performed by the controller 21 on the temperature sensation presentation units 30 will be described. The control performed by the controller 21 on the temperature sensation presentation units 30 will hereinafter be referred to as temperature sensation presentation control. As described in detail below, temperature sensation presentation control includes, in addition to presentation of warm sensation by heating and presentation of cold sensation by cooling, presentation of pseudo pain sensation by a combination of heating and cooling.

As a first example, the controller 21 may immediately heat or cool the plurality of temperature sensation presentation units 30 to a given target temperature, according to an instruction received from the information processing device 10. This allows the operation device 20 to present, at a desired timing, warm sensation or cold sensation to the index figure of the user that is in contact with the surface of the relevant trigger button 25.

Note that whether to execute the heating control or the cooling control according to an instruction received from the information processing device 10 may be determined depending on the difference between the current temperature measured by the temperature sensor 34 and the target temperature. For example, the controller 21 performs heating control when the target temperature is higher than the current temperature (room temperature prior to performance of the temperature sensation presentation control), and performs cooling control when the target temperature is lower than the current temperature.

As a second example, the controller 21 can simultaneously heat and cool the plurality of temperature sensation presentation units 30 in such a manner that one temperature sensation presentation unit 30 is heated while an adjacent one is cooled, according to an instruction received from the information processing device 10, to present pseudo pain sensation to the user. It is known that, when warm sensation and cold sensation are presented simultaneously at a position that is relatively close to the surface of the skin of a human body, pain sensation called thermal grill illusion occurs. Hence, simultaneously presenting warm sensation and cold sensation to the body of the user by heating and cooling the plurality of temperature sensation presentation units 30 which are disposed side by side, in such a manner that one temperature sensation presentation unit 30 is heated while an adjacent one is cooled makes it possible to present pseudo pain sensation to the user in a relatively safe method. In this instance, the greater the temperature difference between the warm sensation and the cold sensation presented by the adjacent temperature sensation presentation units 30, the stronger the pain is to be felt. As such, the controller 21 can control the magnitude of the pain sensation to be felt by the user, by controlling the temperature difference to be presented by the temperature sensation presentation units 30.

As a third example, the operation device 20 may control the contents of presentation of warm or cold sensation and the timing of presentation, according to the details of operation (for example, the operation amount, the operation speed, and the like) performed by the user on the trigger button 25. Specifically, the operation device 20 monitors the result of measurement of the push-in amount of the trigger button 25, and causes the temperature sensation presentation units 30 to generate heat or absorb heat in a case where the value of the measurement result satisfies given conditions.

More specifically, for example, the operation device 20 increases the temperature to be presented by the temperature sensation presentation units 30 in a stepwise manner, as the push-in amount increases. This allows the user to experience more hotness as the user pushes in the trigger button 25 harder. As a result, the user can experience a sense as if the user were gripping something hot. Conversely, the operation device 20 may lower the temperature to be presented by the temperature sensation presentation units 30 in a stepwise manner, as the push-in amount of the trigger button 25 increases.

As a fourth example, the operation device 20 may present pseudo pain sensation according to the details of operation performed by the user on the trigger button 25. In this example, as in the second example, the plurality of temperature sensation presentation units 30 are caused to generate heat and absorb heat in such a manner that one temperature sensation presentation unit 30 generates heat while an adjacent one absorbs heat, to present pseudo pain sensation to the user. However, in this example, as in the third example, the contents and the timing of presentation of the pseudo pain sensation are controlled according to the details of operation performed by the user on the trigger button 25. This enables such control that the harder the user pushes in the trigger button 25, the stronger the user feels the pain sensation.

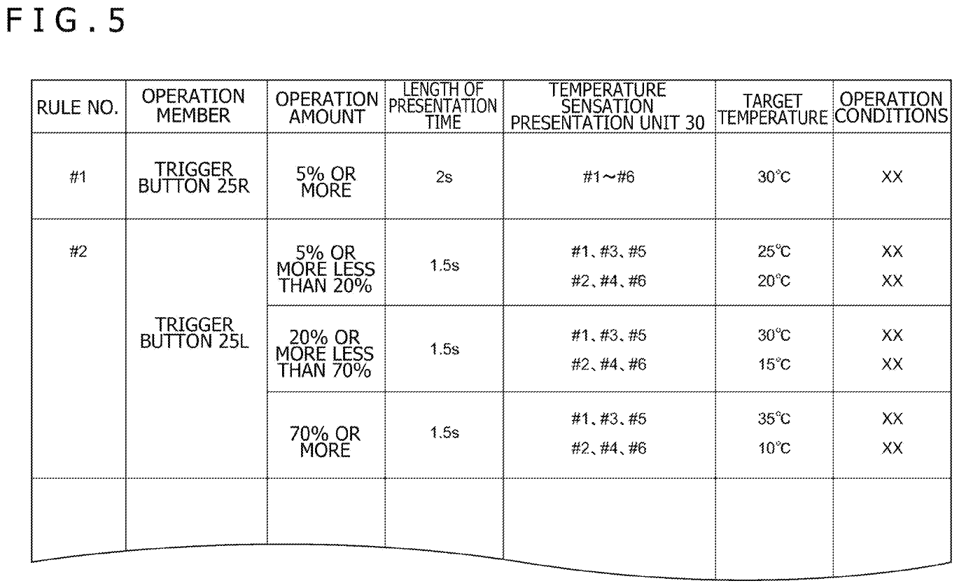

The temperature sensation presentation control performed by the controller 21 as described above is performed according to the instruction received from the information processing device 10. This instruction may be one that is received from the information processing device 10 in a rule table form in which the details of the instruction are described. FIG. 5 illustrates an example of the rule table received by the operation device 20 from the information processing device 10. In this example, the rule table includes a plurality of rules. Each rule includes a combination of parameters for the subject operation member, the operation amount that serves as a condition for applying the rule, length of presentation time, the subject temperature sensation presentation unit 30, target temperature, and operation conditions. Note that the contents of the rule table illustrated here are mere examples, and the information processing device 10 may give an instruction on the contents of temperature sensation presentation control in a different data form.

In the example illustrated in the figure, the parameters for the operation amount are set in association with the subject operation member. The parameters each indicate the relevant rule to be applied for each case where the operation member is operated in the respective operation amount. Here, with respect to the left or right trigger button 25R or 25L, the range of ratio to the maximum value of the push-in amount of the relevant trigger button 25 is associated as the parameter for the operation amount. A plurality of numerical ranges of the push-in amount may be associated with one trigger button 25, and in that case, the relevant one of the plurality of rules will be applied according to the extent to which the user has pushed in the trigger button 25.

The parameters for the target temperature and the operation conditions are set for each of the plurality of temperature sensation presentation units 30. The operation conditions are values indicating the specific conditions under which the thermoelectric element section 31 is to be operated. For example, in a case where the source circuit 33 causes a current to flow in the thermoelectric element section 31 in a pulse-width modulation method, the parameters for the operation conditions may be a duty cycle or a frequency of a pulse wave. Note that, in a case where the temperature sensation presentation units 30 are to be operated constantly at a fixed output, the parameters for the output value are not necessarily required to be included in the rule table. Moreover, in a case where the plurality of temperature sensation presentation units 30 are to be operated at a common output value, the parameters for the output values may, instead of being set for each of the temperature sensation presentation units 30, be set for a combination of the operation member and the operation amount.

In the example illustrated in FIG. 5, rule number #1 indicates the rules of warm sensation presentation control. In this example, when the trigger button 25R is pressed down in a push-in amount equal to or greater than 5% of the maximum value of the push-in amount, warm sensation presentation control of heating all the temperature sensation presentation units 30 to 30° C. is performed. Similarly, rule number #2 indicates the rules for presenting pseudo pain sensation to the trigger button 25L. In this example, when the trigger button 25L is pressed down in a push-in amount equal to or greater than 5%, heating or cooling control is performed on each of the temperature sensation presentation unit 30 such that the temperature difference between the adjacent temperature sensation presentation units 30 becomes 5° C. This causes the user to feel a slight pain in his/her left index finger. Further, when the user presses down the trigger button 25L to such an extent that the push-in amount becomes equal to or greater than 20%, the temperature difference between the adjacent temperature sensation presentation units 30 becomes 15° C., and when the push-in amount becomes equal to or greater than 70%, the temperature difference becomes 25° C. This causes the user to gradually feel more pain in his/her left index finger in a stepwise fashion.

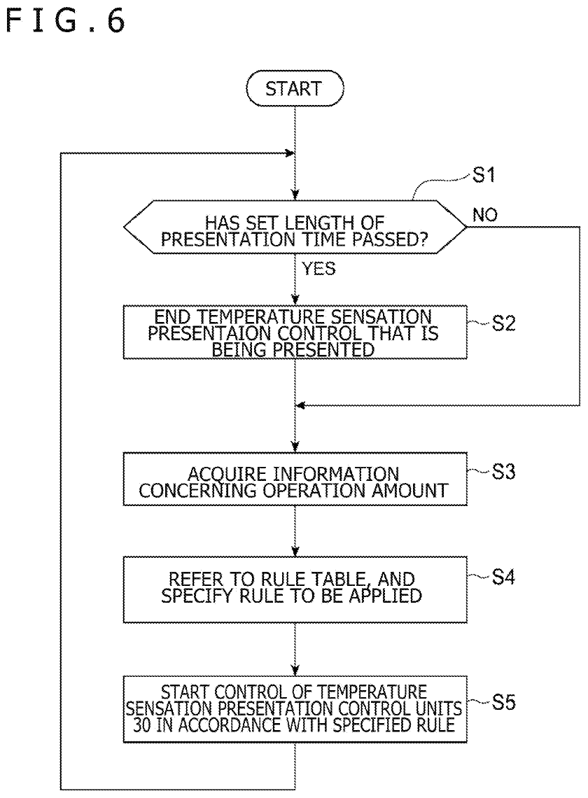

In the following description, an example of a flow of control performed by the controller 21 with use of the rule table as the one described above will be described with reference to a flowchart of FIG. 6. When control based on the rule table is started, the controller 21 performs the following loop process until an instruction for ending the process is given. Specifically, first, the controller 21 determines whether the length of presentation time set in the rule table has passed with respect to the temperature sensation presentation control that is currently being performed (S1). When the set length of presentation time has passed, the performance of the temperature sensation presentation control is ended, and the heating or cooling of the subject temperature sensation presentation unit 30 is stopped (S2).

Next, the controller 21 acquires information concerning the current operation amount with respect to the subject operation member (S3). Here, the controller 21 acquires the value of the push-in amount measured and indicated by the push-in amount measurement mechanism 26, with respect to both the left and right trigger buttons 25.

Further, the controller 21 refers to the rule table and specifies the rule to be newly applied, in reference to the acquired value of push-in amount (S4). Thereafter, the controller 21 starts the temperature sensation presentation control corresponding to the set parameters for the target temperature and the operation conditions, for each of the temperature sensation presentation units 30 defined in the specified rule (S5). Note that, in a case where temperature sensation presentation control based on the new rule is to be started for the temperature sensation presentation unit 30 for which temperature sensation presentation control is already being performed, the control that had been performed is stopped. The controller 21 continuously and repetitively performs the abovementioned process until an instruction for ending the process is received. This makes it possible to perform temperature sensation presentation control based on a rule table, on a real time basis.

The information processing device 10 can also update the rule table stored in the memory 22 of the operation device 20, according to the progress of the application program being performed and the transition in the state of the system menu included in the operation system program. For example, the information processing device 10 executes a game program, and transmits to the operation device 20 a new rule table every time the game scene changes. Upon receiving a new rule table, the controller 21 of the operation device 20 ceases the temperature sensation presentation control that is being performed in reference to the old rule table, and starts the control based on the new rule table. This makes it possible to perform temperature sensation presentation control corresponding to the situation in the game being played by the user, such as presenting warm sensation to the finger of the user without interruption in one scene or presenting pseudo pain sensation corresponding to the strength of pushing in the trigger buttons 25 by the user in another scene. Specifically, according to the present embodiment, in such scenes where the user's hand or fingers are caught in a door, the user pricks his/her finger on a rose thorn, or the user carries his/her weight on one finger during rock climbing in the virtual space, pseudo pain sensation can be presented to the user's finger.

Further, the information processing device 10 according to the present embodiment may be configured such that, in a case where the user tries to perform an operation with restrictions, such as selecting a selection-prohibited icon that is displayed in the system menu, the information processing device 10 uses a warning sound or the like to notify the user that the user is prohibited from selecting the icon and also informs the user of the same by presenting pseudo pain sensation to the balls of the fingers placed on the trigger buttons 25, for example. This makes it possible to notify visually impaired people or hearing-impaired people that they have tried to perform a prohibited operation, and more improved accessibility performance can be expected. Note that, in the present embodiment, the magnitude of the pain sensation (pain) to be felt by the user can be changed in a stepwise manner.

Note that, the rule table is not limited to the one received from the information processing device 10, and may be one provided beforehand in the operation device 20. For example, a default rule table is provided beforehand in the operation device 20, and the controller 21 may perform such control as the one described above, by using the default rule table, during the period in which no instruction is being received from the information processing device 10 with respect to the rule table to be applied.

Here, a specific example of the shape and the arrangement of the plurality of temperature sensation presentation units 30 will be described. As described above, in the example of FIG. 2, the plurality of temperature sensation presentation units 30 are arranged side by side in the left-right direction. Further, the width (length) of each of the temperature sensation presentation units 30 along the arrangement direction is shorter than the length thereof in the direction (the longitudinal direction of the temperature sensation presentation units 30) intersecting the arrangement direction. Moreover, the arrangement direction of the plurality of temperature sensation presentation units 30 in this example substantially matches the direction in which the user's index fingers extend at the time of operating the trigger buttons 25. In this manner, arranging the temperature sensation presentation units 30 each having a relatively narrow width side by side along the direction in which the user's fingers extend at the time of operating the operation members makes it possible to simultaneously present warm sensation and cold sensation to the user's fingers without fail. That is, such an arrangement increases the possibility of the user's fingers coming into contact with at least any two adjacent temperature sensation presentation units 30, even when the user's finger positions shift side to side or up and down. Consequently, causing the plurality of the temperature sensation presentation units 30 to generate and absorb heat in such a manner that, while one temperature sensation presentation unit 30 generates heat, the adjacent one absorbs heat makes it possible to simultaneously heat and cool the user's body without fail and to present pseudo pain sensation.

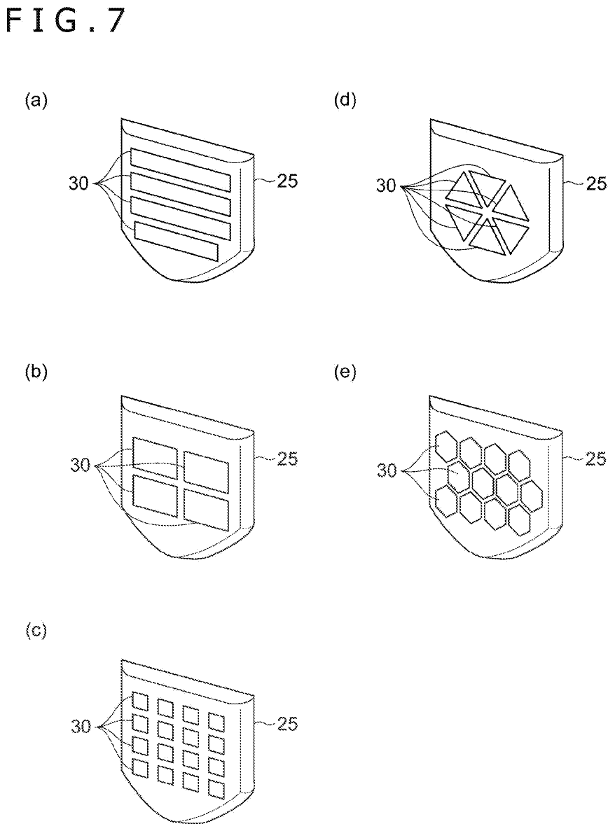

However, the shape and the arrangement of the temperature sensation presentation units 30 are not limited to those described above. FIG. 7 illustrates some examples of arranging the temperature sensation presentation units 30. In FIG. 7(a), reed-shaped temperature sensation presentation units 30 extending in the horizontal direction are arranged side by side along the direction (that is, the up-down direction) intersecting the arrangement direction illustrated in FIG. 2. In FIG. 7(b), substantially square-shaped temperature sensation presentation units 30 are arranged vertically and horizontally. In FIG. 7(c), temperature sensation presentation units 30 that similarly have a substantially square shape but are slightly smaller than those in the case of FIG. 7(b) are disposed in a scattered manner. In FIG. 7(d), unlike those in the above described cases, the surface shape of each of the temperature sensation presentation units 30 has a substantially rectangular shape, and six temperature sensation presentation units 30 of such kind are annularly arranged to form a hexagonal shape. In FIG. 7(e), the surface shape of each of the temperature sensation presentation units 30 has a substantially hexagonal shape, and the temperature sensation presentation units 30 are arranged in an orderly fashion within a limited range to form a hexagonal grid. In each of these examples, each temperature sensation presentation unit 30 has substantially the same shape and the same size, and the temperature sensation presentation units 30 are arranged side by side to avoid any substantial gap between them. This allows the user to be presented with pseudo pain sensation by a temperature difference being generated between adjacent temperature sensation presentation units 30.

As described above, the operation device 20 according to the present embodiment can present to the user various kinds of tactile sensation by presenting warm or cold sensation or pseudo pain sensation obtained by a combination of warm sensation and cold sensation to the part of the body of the user that is operating the operation member.

Note that the embodiment of the present invention is not limited to the one described above. For example, in the following description, a Peltier element is used as the thermoelectric element section 31, and the direction of the current to be flowed into the thermoelectric element section 31 is controlled to use one temperature sensation presentation unit 30 for presentation of both warm sensation and cold sensation. However, this configuration is not restrictive, and each temperature sensation presentation unit 30 may be used to present only one of the warm sensation or the cold sensation. Also in this case, alternately arranging the temperature sensation presentation unit 30 for presenting warm sensation and the temperature sensation presentation unit 30 for presenting cold sensation side by side in a plurality of sets makes it possible to realize each of presentation of warm sensation, presentation of cold sensation, and presentation of pseudo pain sensation.

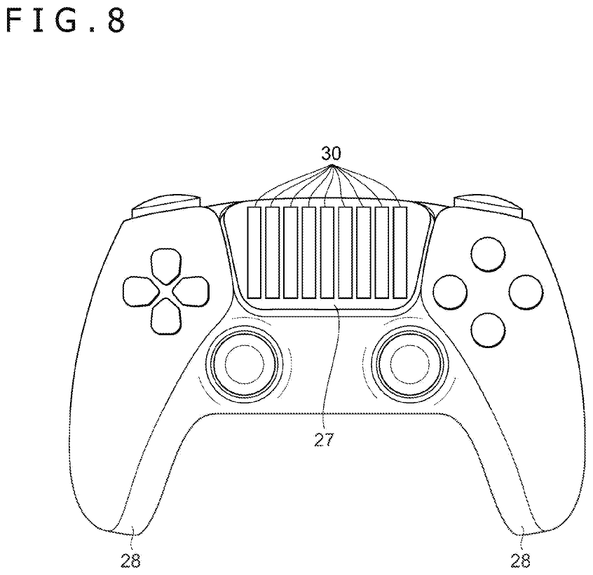

Further, in the above description, the temperature sensation presentation units 30 are arranged on the surface of the trigger button 25 the push-in amount of which can be measured, but this configuration is not restrictive, and the temperature sensation presentation units 30 may be arranged for various operation members. As a specific example, the plurality of temperature sensation presentation units 30 may be arranged on a surface of the touch pad 27 that can detect contact with the user's body. FIG. 8 illustrates an example in which the plurality of temperature sensation presentation units 30 are arranged on the touch pad 27 that is disposed on an upper surface of the operation device 20. Arranging the temperature sensation presentation units 30 on the surface of the touch pad 27 in such a manner makes it possible to present warm sensation, cold sensation, and further pseudo pain sensation to the user's finger when the user's finger touches the touch pad 27 and performs a sliding operation, for example.

Moreover, the touch pad 27 may be configured to receive the strength of pressure applied by the user's finger, as one kind of amount of operation performed on the touch pad 27 by the user. In this case, the touch pad 27 is provided with a pressure-sensitive sensor for measuring the pressure. The controller 21 may present warm or cold sensation or pseudo pain sensation to the user, according to the results of measurement by the pressure-sensitive sensor. Specifically, as in the third and fourth control examples concerning the trigger buttons 25 described above, the contents of warm or cold sensation and pain sensation to be presented are changed according to the magnitude of the pressure measured by the pressure-sensitive sensor. As a result, such control as presenting stronger pain sensation as the finger touches the touch pad 27 with stronger force, for example, can be realized.

Further, on a surface of the holding portion 28 which is a portion of the operation device 20 that is to be gripped by the palm of the user's hand, a pressure-sensitive sensor for measuring the strength of gripping by the user's hand may be disposed. In this case, the results of measurement by this pressure-sensitive sensor can be used as part of information indicating the state of operation by the user. Further, in the present embodiment, the temperature sensation presentation units 30 may be disposed on the surface of the grip button. This allows warm sensation, cold sensation, or pseudo pain sensation to be presented to the palm of the user's hand. Further, in this case, the contents of the temperature sensation presentation control may be changed according to the results of measurement performed by the pressure-sensitive sensor disposed on the surface of the holding portion 28. This makes it possible to perform such control that, when the user grips the holding portion 28 with strong force, pseudo pain sensation is presented to the palm of the hand or the ball of the finger that is in contact with the surface of the holding portion 28.

Further, as the details of operation performed by the user on the operation member in the above description, such operation amounts as the push-in amount measured by the push-in amount measurement mechanism 26 and the strength of pressure measured by the pressure-sensitive sensor are used, but this configuration is not restrictive, and the controller 21 may perform temperature sensation presentation control according to the details of various operations performed by the user.

For example, the controller 21 may perform temperature sensation presentation control on such a condition that no user operation is performed. In this example, such control as presenting warm sensation in a case where the operation amount with respect to the operation member is 0 or less than a predetermined value is performed. This allows the user to be aware of being in a state of waiting for an operation or makes it possible to prompt the user to perform any kind of operation.

Further, the controller 21 may perform specific temperature sensation presentation control in a case where any operation is performed on an operation member that is provided for the purpose of merely specifying whether an operation has been performed or not, such as an operation button, or in a case where no operation is performed for such an operation member.

Further, the controller 21 may perform temperature sensation presentation control according to the speed of an operation performed on the specific operation member. For example, in a case where the user has performed an operation of quickly pushing in the trigger button 25, the controller 21 may perform temperature sensation presentation control that causes the user to feel stronger pain than in the case where the user slowly pushes in the trigger button 25.

Further, the controller 21 may perform temperature sensation presentation control according to the number of times of operation performed on a specific operation member. For example, the controller 21 may decide the contents of temperature sensation presentation control according to the number of times the operation button has been pressed within a predetermined period of time.

Further, the contents of temperature sensation presentation control may, instead of being decided uniquely by a rule table, be varied depending on the user who is currently using the operation device 20, for example. The sense of feeling hot, cold, or pain is considered to be different with each person. Hence, the controller 21 may refer to a table prepared in advance, for example, and correct the target temperature to be used at the time of presenting warm sensation or cold sensation, the temperature difference to be used at the time of presenting pseudo pain sensation, or the like for each user with respect to the value instructed by the information processing device 10. Moreover, the controller 21 may set beforehand an upper limit value and/or a lower limit value for the target temperature, temperature difference, or the like for each user and perform temperature sensation presentation control between the upper limit value and the lower limit value. Similarly, for example, also in the case where a game or an application is being played while remote communication with a desired user is being performed in an online game or an online social networking service (SNS), the controller 21 may correct the value of the target temperature, the temperature difference between the adjacent temperature sensation presentation units 30, or the like for each communication content or progress in the game with respect to the value instructed by the information processing device 10.

Further, in the above description, in a case where warm sensation or cold sensation is to be presented, the plurality of temperature sensation presentation units 30 included in one operation member are controlled at the same temperature, but this configuration is not restrictive, and the temperature sensation presentation units 30 may be controlled under different conditions. This makes it possible to, for example, perform temperature sensation presentation control in which the features of the object that is to be operated by the user in the virtual space, temperature distribution thereof, state of movement of the temperature, or the movement direction thereof is more reflected by, for example, setting a higher target temperature for the temperature sensation presentation units 30 placed near the tip of the user's finger.

Further, also in a case where pseudo pain sensation is to be presented, control may be performed in such a manner that the temperature difference between the adjacent temperature sensation presentation units 30 is different depending on the position on the surface of the operation member. Further, among the plurality of temperature sensation presentation units 30 disposed on one operation member, only some of the temperature sensation presentation units 30 may be subject to control. This makes it possible to vary the magnitude of pain to be felt by the user as a whole or vary the magnitude of pain to be felt by the user depending on the position on the surface of the operation member.

Further, the shape of the operation device 20 and the operation member included in the operation device 20 described above are mere examples, and the present invention is applicable to various kinds of operation devices. For example, in the case of an operation device of a type that is to be held or gripped by the user with one hand, the plurality of temperature sensation presentation units 30 may be disposed on the surface of the operation button or the like that is to be operated by the user, and warm or cold sensation or pseudo pain sensation may be presented to the finger of the user that is operating the operation button, as in the examples previously explained. Further, a pressure-sensitive sensor may be disposed on the holding portion or the gripping portion that is to be held or gripped by the palm of the user's hand, and warm or cold sensation or pseudo pain sensation may be presented to the palm of the user's hand according to the result of measurement performed by the pressure-sensitive sensor. Further, in the case of an operation device that is to be operated by being gripped by the user with his/her hand, such as an operation device of a steering wheel type, a pressure-sensitive sensor may similarly be disposed at a position that is to be gripped by the palm of the user's hand, and warm or cold sensation or pseudo pain sensation may be presented to the palm of the user's hand according to the result of measurement.

Further, in the above description, the controller 21 incorporated in the operation device 20 decides the contents of the temperature sensation presentation control to be performed, according to the amount of operation performed on the operation member. That is, the controller 21 is functioning as a control device of the operation device according to an embodiment of the present invention. However, this is not restrictive, and the information processing device 10 that has established communication connection with the operation device 20 may function as the control device of the operation device according to an embodiment of the present invention. In this case, the operation device 20 transmits, to the information processing device 10, on a real time basis, operation information indicating the details of operation performed by the user on the operation members included in the operation device 20, such as the pushing-in amount of the trigger buttons 25. The information processing device 10 decides the contents of temperature sensation presentation control to be performed by the relevant temperature sensation presentation units 30, in reference to the operation information, and transmits the details of instruction to the operation device 20. The controller 21 of the operation device 20 operates the temperature sensation presentation units 30 in accordance with the details of the received instruction. In this case, the operation device 20 need not retain the rule table, and the contents of temperature sensation presentation control can be changed as needed, according to the contents of processing in the application program being executed by the information processing device 10.

### REFERENCE SIGNS LIST

1: Information processing system
10: Information processing device
11: Control unit
12: Storage unit
13: Interface unit
14: Display device
20: Operation device
21: Controller
22: Memory
23: Communication control circuit
24: Input/output interface
25: Trigger button
26: Push-in amount measurement mechanism
27: Touch pad
28: Holding portion
30: Temperature sensation presentation unit
31: Thermoelectric element section
32: Heat dissipation member
33: Source circuit
34: Temperature sensor

1. An operation device comprising:
an operation member configured to receive an operation performed by a user; and
a temperature sensation presentation unit that is disposed on a surface of the operation member and that is configured to present warm sensation and/or cold sensation to a part of a body of the user that is operating the operation member.

2. The operation device according to claim 1, wherein the temperature sensation presentation control unit presents warm sensation and/or cold sensation with contents corresponding to details of the operation performed by the user on the operation member.

3. The operation device according to claim 2, wherein
the operation member is a button including a push-in amount measurement mechanism that is configured to measure a push-in amount, and
the temperature sensation presentation unit presents warm sensation and/or cold sensation with the contents corresponding to the push-in amount measured by the push-in amount measurement mechanism.

4. The operation device according to claim 2, wherein
the operation member includes a pressure-sensitive sensor configured to measure a pressure caused by the part of the body of the user, and
the temperature sensation presentation unit presents warm sensation and/or cold sensation with the contents corresponding to the pressure measured by the pressure-sensitive sensor.

5. The operation device according to claim 1, wherein,
on the surface of the operation member, a plurality of temperature sensation presentation units are disposed adjacent to each other, and
the plurality of temperature sensation presentation units disposed adjacent to each other present pseudo pain sensation to the part of the body of the user, by presenting sensation in different temperatures.

6. The operation device according to claim 5, wherein the plurality of temperature sensation presentation units present sensation in different temperatures with a temperature difference that is decided depending on the details of operation performed by the user on the operation member.

7. A control device of an operation device including an operation member configured to receive an operation performed by a user and a temperature sensation presentation unit configured to present warm sensation and/or cold sensation to a part of a body of the user that is operating the operation member, the control device comprising:
an acquisition unit configured to acquire details of the operation performed by the user on the operation member; and
a control unit configured to cause the temperature sensation presentation unit to present warm sensation and/or cold sensation with contents corresponding to the acquired details of operation.

8. A control method for an operation device including an operation member configured to receive an operation performed by a user and a temperature sensation presentation unit configured to present warm sensation and/or cold sensation to a part of a body of the user that is operating the operation member, the control method comprising:
acquiring details of the operation performed by the user on the operation member; and
causing the temperature sensation presentation unit to present warm sensation and/or cold sensation with contents corresponding to the acquired details of operation.

9. A non-transitory, computer-readable storage medium containing a computer program for controlling an operation device including an operation member configured to receive an operation performed by a user and a temperature sensation presentation unit configured to present warm sensation and/or cold sensation to a part of a body of the user that is operating the operation member, the program causing a computer to carry out a control method, comprising:
acquiring details of the operation performed by the user on the operation member; and
causing the temperature sensation presentation unit to present warm sensation and/or cold sensation with contents corresponding to the acquired details of operation.
